(19) United States
(12) Patent Application Publication
(10) Pub. No.: US 2010/0116726 A1
(43) Pub. Date: May 13, 2010

(54) EFFLUENT DISCHARGE

(76) Inventors: David Dwek, London (GB); Murray Eldridge, Berkshire (GB); Tim Haysom, London (GB); Duncan Barclay, London (GB)

Correspondence Address: KLEIN, O'NEILL & SINGH, LLP, 43 CORPORATE PARK, SUITE 204, IRVINE, CA, 92606, US

(21) Appl. No.: 12/593,176

(22) PCT Filed: Apr. 1, 2008
(86) PCT No.: PCT/GB08/01152

§ 371 Date: Dec. 28, 2009

(30) Foreign Application Priority Data
Apr. 2, 2007 (GB) 0706410.8

(51) Int. Cl. E03B 3/04; B60P 3/22

(52) U.S. Cl. 210/170.11; 137/899.2

(57) ABSTRACT

Apparatus for discharging effluent from a sea-based vessel (10) comprises a branched pipeline (22) which is disposed on the seabed (18). The vessel (10) carries a large-scale desalination plant (12), and the effluent, which is in the form of concentrated brine, is pumped through the branched pipeline (22) to a plurality of discharge locations on the seabed. The branched pipeline (22) includes a number of flexible discharge pipes (26a d) which fan out from a common location (30) towards open ends (28a-d). The open ends (28a d) are remote from each other, and the effluent is discharged simultaneously through the open ends (28a d) causing it to be dispersed effectively without harming surrounding eco-systems. In an alternative arrangement, a vessel-based water purification plant (10) is connected to a freshwater pipeline (16) and to a discharge pipeline (22), each of which is disposed on the seabed (18). Purified water is pumped to shore from the vessel (10) through the freshwater pipeline (16), and effluent is pumped from the vessel (10) into the sea (14) through the discharge pipeline (22).

The present invention relates generally to effluent discharge, and more particularly to the discharge of concentrated brine from a desalination plant onboard a sea-based vessel.

Fresh water is becoming increasingly scarce in many parts of the world for various reasons including global warming, pollution, expanding populations, heavy irrigation and deforestation. Desalination, which is the process of removing salt from salt water to produce fresh water, is becoming an increasingly popular solution to the problem of shortage of fresh water.

Large-scale desalination plants, which are located off-shore on ships or other floating vessels, may prove to be an effective way of combating water shortages. Such ‘vessel-based’ desalination plants provide many advantages over land-based desalination plants. For example, whereas the location of land-based desalination plants is fixed, vessel-based desalination plants can be moved and can therefore supply fresh water wherever and whenever it is most needed.

In addition to producing fresh water, desalination also produces a waste product, or effluent, which is a concentrated or ‘hypersaline’ brine containing all of the solutes and suspended solids removed from the salt water to produce fresh water. The effluent may also contain water treatment chemicals, and chemicals used for cleaning the desalination equipment. With vessel-based desalination plants, and also with many land-based plants, the effluent is discharged back into the sea. It is important, however, that this is disposed of in such a way that it does not harm the surrounding ecosystems.

The present invention seeks to provide an efficient and eco-friendly system for discharging the effluent from a vessel-based desalination plant. The invention also seeks to provide an improved vessel-based desalinating plant incorporating such an effluent discharge system.

According to a first aspect of the present invention there is provided an apparatus for discharging effluent from a water-based vessel, the apparatus comprising means for causing the effluent to be introduced into the water at a plurality of discharge locations relative to the vessel, wherein the discharge locations are remote from each other thereby causing the discharged effluent to be dispersed in the surrounding water.

The vessel is preferably located at sea. Preferably the effluent is discharged simultaneously at the plurality of discharge locations.

In preferred embodiments of the invention, the apparatus comprises conveying means for conveying the effluent to the plurality of discharge locations. The conveying means preferably comprises a branched pipe assembly having one or more inlet pipes connected to a plurality of outlet pipes. Preferably the branched pipe assembly has a plurality of outlets through which, in use, the effluent is discharged. The outlets may be defined by respective open ends of the outlet pipes, or the outlets may be located at other locations along the lengths of the outlet pipes. The outlet pipes are preferably arranged to fan out from a common location, and may extend in directions within all four quadrants of a circle centred on the common location, in other words such that each adjacent pair of radial outlet pipes are oriented at an angle of less than 90 degrees to each other. The outlets may be arranged substantially in a circle. The common location may advantageously be on or directly below the vessel.

Preferably a manifold connects the inlet and outlet pipes. The manifold may have one or more manifold inlets and a plurality of manifold outlets. The one or more inlet pipes may be respectively connected to the one or more manifold inlets, and the plurality of outlet pipes may be respectively connected to the plurality of manifold outlets. In other embodiments of the invention, instead of being connected by a manifold, the inlet and outlet pipes may be welded together or joined by any other suitable technique. Moreover, the inlet and outlet pipes could instead form part of a branched pipe assembly having a monolithic structure.

The length of each outlet pipe is typically between about 200 m and 10 km, and the length of the or each inlet pipe is typically between about 50 m and 2 km. However, in some embodiments the inlet and/or outlet pipes may have lengths that fall outside these ranges. The water conditions may affect the lengths of pipes that are suitable, for example, shorter pipes may be used when there are relatively strong currents that can disperse the effluent effectively.

The inlet and outlet pipes may be formed from high-density polyethylene (HDPE) or other suitable materials. The inlet pipes may have diameters up to 500 mm, and advantageously between about 300 to 350 mm, whereas the outlet pipes may have diameters up to 1500 mm, and advantageously between about 150 to 200 mm. The diameters of the pipes depend on the scale of the water purification plant, and for large plants the pipes may have diameters in the region of 1.5 m.

The outlets are preferably located underwater and in preferred embodiments of the invention are located on or close to the seabed. The apparatus may comprise one or more risers for connecting the branched pipe assembly to a source of effluent onboard the vessel. The risers preferably include some slack so that the vessel can move about without stresses arising in the connection to the branched pipe assembly on the seabed. To further prevent or minimise these stresses, the or each riser may be supported part-way along its length by an underwater buoyancy aid.

In an alternative embodiment of the invention, the conveying means may comprise a single pipeline, or at least a non-branched pipeline, which has a plurality of outlets spaced apart from each other along the length of the pipeline.

In order to minimise the impact on eco-systems close to the discharge outlets, the apparatus preferably comprises means for diluting the effluent before it is discharged. The diluting means may be arranged to mix the effluent with seawater before it is discharged. This mixing process may take place onboard the vessel in large tanks and can reduce the salinity of the effluent to a salinity close to that of seawater.

In order to disperse the effluent most effectively, it is preferable that the discharge locations are spaced apart from each other by distances in excess of about 200 m. However, the relative separation of the discharge outlets may be reduced if the vessel is located in a body of water that has relatively efficient effluent dispersal characteristics, resulting from tidal conditions or strong currents for example. It is also preferable for the discharge locations to be remote from the raw water inlets when the apparatus is used in a desalination or water purification plant respectively so that the effluent is not taken in through the raw water inlets after it has been discharged. The raw water inlets may be close to the vessel, in which case the discharge locations are preferably remote from the vessel. The discharge locations are typically between about 250 m and 12 km from the vessel, depending on the inherent water conditions as discussed previously. In other embodiments of the invention, the raw water inlets may themselves be remote from the vessel. It is preferable that the raw water inlets are within about 0.5 km of the vessel. In either case, the raw water inlets and the discharge outlets are preferably separated by about 250 m to 12 km.

According to a second aspect of the present invention, there is provided a method of discharging effluent from a water-based vessel, the method comprising introducing effluent into the water at a plurality of discharge locations relative to the vessel, wherein the discharge locations are remote from each other such that the discharged effluent is dispersed in the surrounding water.

Preferably the method is used to discharge effluent from a sea-based vessel. Preferably the effluent is introduced into the water simultaneously at the plurality of discharge locations.

The method preferably comprises conveying effluent to the plurality of discharge locations. The effluent may be conveyed through a plurality of pipes. Preferably the effluent is conveyed through a branched pipe assembly.

The discharge locations are preferably spaced apart from each other by in excess of about 200 m. However, as discussed above, the relative separation of the discharge outlets may be reduced if the vessel is located in a body of water that has relatively efficient effluent dispersal characteristics, resulting from tidal conditions or strong currents for example. The discharge locations may be located remote from the vessel. The discharge locations are typically between about 250 m and 12 km from the vessel, depending on the inherent water conditions as mentioned above. Preferably the effluent is discharged underwater. The effluent may be discharged close to the surface of the water or closer towards the seabed. Preferably the effluent is discharged substantially on the seabed.

The effluent may be pre-mixed with water before it is discharged. When the method is used on a vessel-based desalination plant, the effluent is concentrated brine. The concentrated brine is preferably pre-mixed with seawater before it is discharged in order to reduce its salinity to a level close to that of seawater.

When the method is used on a vessel-based water purification plant, for example on a vessel-based desalination plant, purified or desalinated water is preferably pumped to shore via a freshwater pipeline extending between the vessel and the shore. The vessel may discharge at port, or the method may include pumping the purified or desalinated water from the vessel into a container located on a barge or similar vessel, which is then tugged to a port where the purified or desalinated water is then offloaded.

The method may further comprise using large containers to store purified or desalinated water offshore, either close to or remote from the vessel. The containers may be manufactured from PVC or fibre, thus making them re-usable. Each container is preferably large enough to store at least 25,000 m³ of water, and may be capable of storing in excess of 30,000 m³. The method may include filling the containers when the containers are in the water. The method may involve pumping water from the vessel, through one or more pipes, and into the or each container. Water stored in the containers may be pumped to shore through a pipeline, or transported to shore on a barge as discussed above.

According to a third aspect of the present invention, there is provided a vessel-based water purification plant comprising: a first riser connecting a source of purified water onboard the vessel to a fresh water pipeline disposed substantially on the seabed, and a second riser connecting a source of effluent onboard the vessel to a discharge pipeline disposed substantially on the seabed, the arrangement being such that purified water is pumped to shore through the fresh water pipeline, and effluent, which is produced during purification, is discharged into the sea through the discharge pipeline.

Preferably the first and second risers are flexible pipes. Each riser may be supported part-way along its length by a buoyancy device located underwater. The risers may be disposed over separate buoyancy devices or alternatively together over a single buoyancy device. Each buoyancy device may be tethered to a respective base on the seabed. The risers are preferably arranged such that there is a portion of slack between the respective buoyancy devices and the vessel. The vessel may be moored with its own anchor pattern or to a buoy, and is preferably moored to a catenary anchor leg mooring (CALM) buoy.

The discharge pipeline may comprise a branched pipe assembly. The branched pipe assembly may comprise a plurality of outlets through which the effluent is discharged. The branched pipe assembly preferably comprises a plurality of pipes which fan out from a common point towards open ends that define respective ones of the outlets. The outlets are typically spaced apart from each other by in excess of about 200 m. However, as discussed above, the relative separation of the discharge outlets may be reduced if the vessel is located in a body of water that has relatively efficient effluent dispersal characteristics, resulting from the particular tidal conditions or strong currents for example. The discharge outlets are typically between about 250 m and 12 km from the vessel, depending on the inherent water conditions as mentioned above.

In certain embodiments of the invention, the plurality of pipes may fan radially outwards from the common point in a spoke and hub arrangement with the outlets being arranged substantially in a circle. Alternatively, the discharge pipeline may comprise a non-branched pipeline which has a plurality of outlets spaced apart from each other at intervals along its length.

The pipelines may be stabilised on the seabed by concrete mattresses positioned on top of the pipelines. A “plough burial” technique may alternatively or additionally be used, whereby the pipelines are laid in furrows on the seabed.

The vessel-based water purification plant is preferably arranged to produce between about 5,000 and 150,000 m³ of purified water per day. However, the invention is of equal application in plants which produce more or less purified water than this. Preferably the water purification plant is a desalination plant, and the effluent is concentrated brine.

In order that this invention may be more readily understood, preferred embodiments of the invention will now be described by way of example with reference to the accompanying drawings, in which:

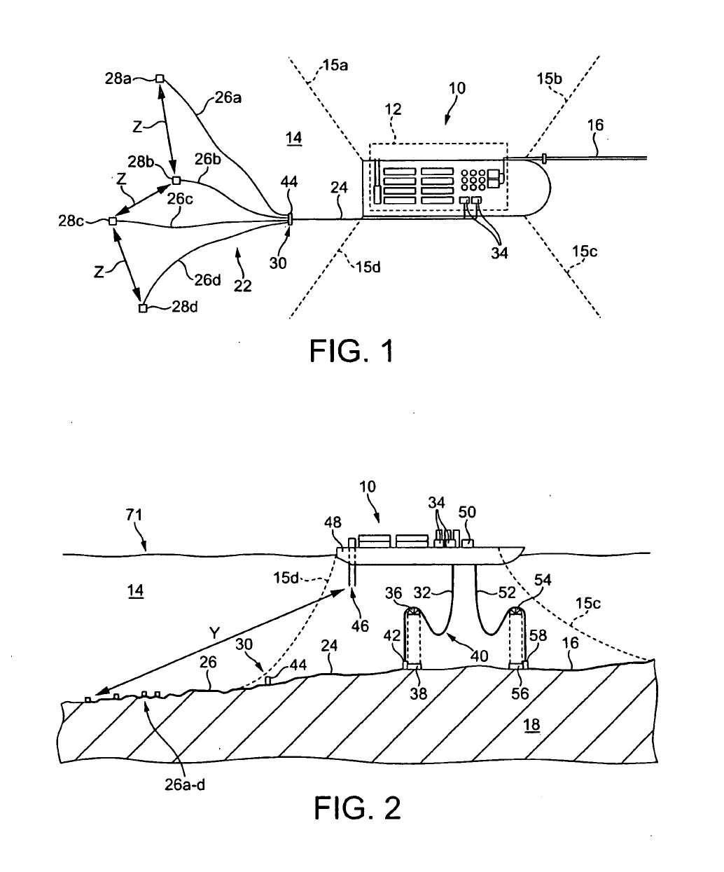

FIG. 1 is a plan view of an effluent discharging apparatus in accordance with a preferred embodiment of the present invention;

FIG. 2 is a side elevation of the apparatus of FIG. 1;

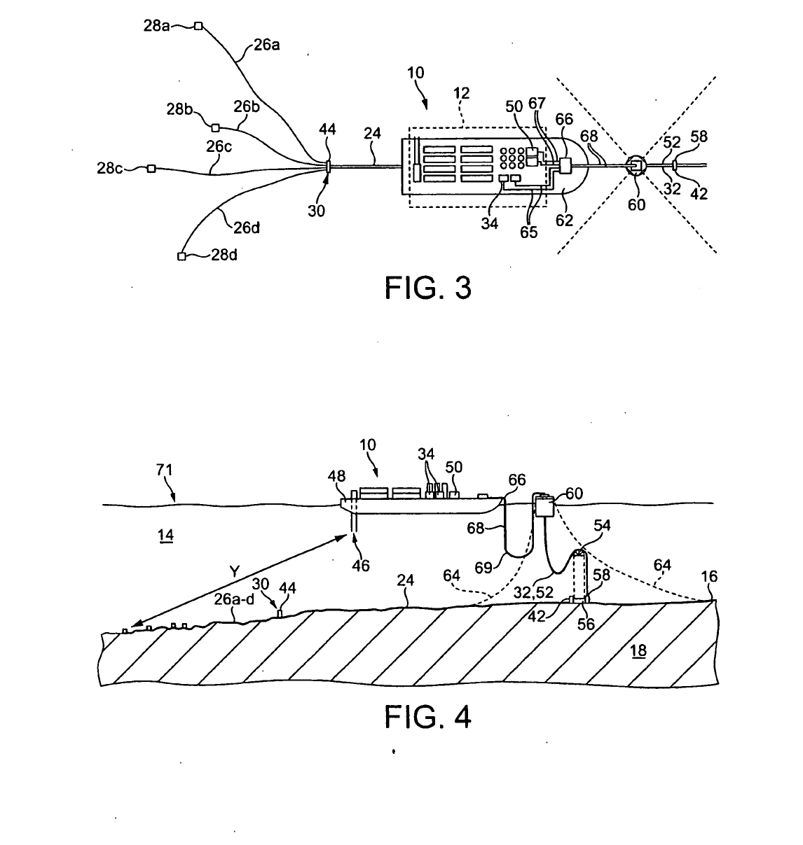

FIG. 3 is a plan view of an effluent discharging apparatus in accordance with an alternative embodiment of the present invention;

FIG. 4 is a side elevation of the apparatus of FIG. 3;

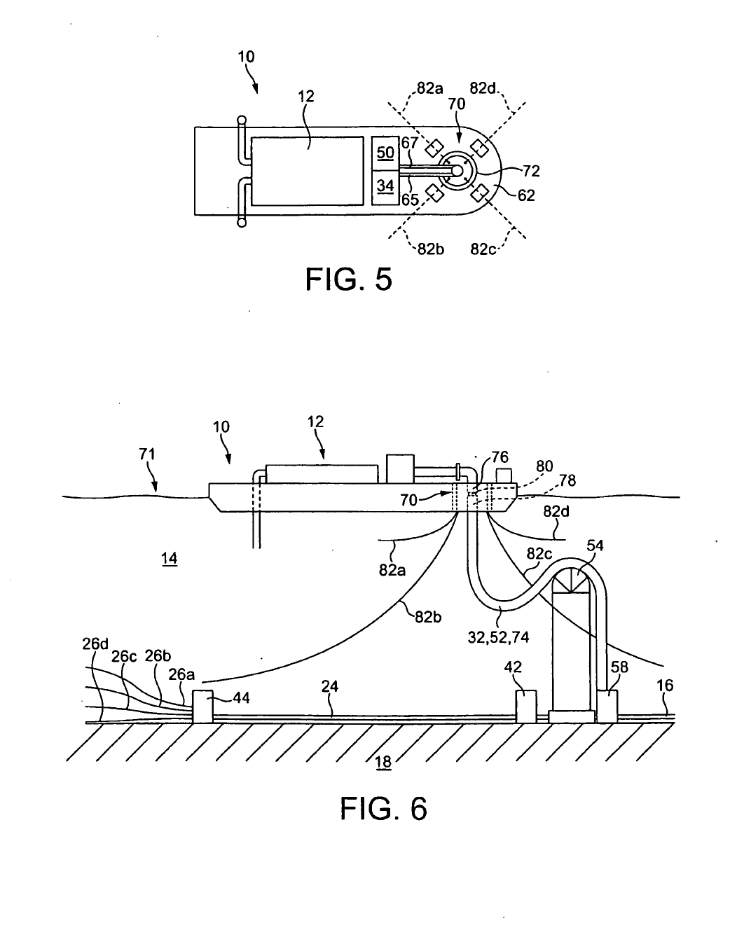

FIG. 5 is a plan view of an effluent discharging apparatus in accordance with a further embodiment of the present invention; and

FIG. 6 is a side elevation of the apparatus of FIG. 5.

FIG. 1 shows a vessel 10 carrying a large-scale desalination plant 12. The vessel 10 comprises a ship, such as an oil tanker, or a barge located at sea 14. The desalination plant 12 utilises a reverse osmosis technique for producing fresh, desalinated water in quantities of between 5,000 to 150,000 m³ per day. The desalinated water is carried to shore by a freshwater pipeline 16 disposed on the seabed 18 (FIG. 2). A discharge system is provided to discharge the effluent produced during desalination into the sea 14 as will be discussed in more detail below. The vessel 10 is stabilised by a fixed mooring comprising lines 15a-d which extend from respective corners of the vessel 10 to four separate locations on the seabed 18 in a catenary, as seen in FIG. 2.

The discharge system comprises a branched pipeline 22 which is disposed on the seabed 18 (FIG. 2) and which extends away from the vessel 10. The branched pipeline 22 includes a pair of flexible primary discharge pipes 24 and a dispersal system that comprises four flexible secondary discharge pipes 26a-d. The primary discharge pipes 24 and the secondary discharge pipes 26a-d are formed from high-density polyethylene (HDPE) or other suitable materials. Each secondary discharge pipe 26a-d has a respective discharge outlet 28a-d, defined by an open end which may be raised off the seabed, through which the effluent is discharged into the sea 14. The four secondary discharge pipes 26a-d fan out from a common point 30 to a plurality of relatively remote locations where the effluent is discharged. The double-headed arrows Z on FIG. 1 indicate the relative separation between adjacent discharge outlets 28a-d. This separation is typically in the range of about 200 m to about 10 km, and ensures that the effluent is dispersed effectively so that it does not harm the surrounding ecosystems.

As can be seen more clearly from FIG. 2, one or more flexible pipes, commonly referred to as ‘risers’ 32, connect a number of effluent tanks 34 onboard the vessel 10 to the primary discharge pipes 24 disposed on the seabed 18. Although not shown in the drawings, in other embodiments of the invention, the effluent tanks 34 may be located in the hull of the vessel 10. The risers 32 are flexible pipes formed from HDPE or other flexible materials. The risers 32 are sufficiently long to accommodate the vertical and lateral movement of the vessel 10 in the sea 14. The risers 32 are also suspended, part-way along their length, by an arch-shaped buoyancy aid 36 which is located underwater and tethered to a base 38 on the seabed 18.

The buoyancy aid 36 prevents the risers 32 from dragging on the seabed 18 when the vessel 10 is directly above the base 38. The base 38 is formed from concrete or steel. Each riser 32 is arranged with respect to the buoyancy aid 36 so that there is a portion of slack 40 between the buoyancy aid 36 and the vessel 10. This arrangement allows each riser 32 to move with respect to the buoyancy aid 36 as the vessel 10 moves, thereby substantially preventing stress at the connection to the primary discharge pipes 24 on the seabed 18. Risers 32 arranged in this way are hereinafter also referred to as ‘dynamic risers’.

A first pipeline end manifold (PLEM) 42 is located adjacent to the base 38 and connects the dynamic risers 32 to the primary discharge pipes 24. The primary discharge pipes 24 extend from respective outlets of the first PLEM 42, to respective inlets of a second PLEM 44. The second PLEM 44 is also disposed on the seabed 18, and is located approximately 0.5 km from the first PLEM 42. The four secondary discharge pipes 26a-d extend from respective outlets of the second PLEM 44.

Before the effluent is discharged, it is mixed with a quantity of seawater in the effluent tanks 34. This dilutes the effluent to a salinity that is close to the salinity of seawater. The resulting dilute effluent is then pumped from the effluent tanks 34, down through the dynamic risers 32, along the primary discharge pipes 24 and out through the discharge outlets 28a-d at the ends of the secondary discharge pipes 28a-d. The effluent is discharged on, or close to, the seabed 18. In addition to being dispersed effectively, the effluent is also discharged far enough away from the vessel 10 in order for it not to affect the continued operation of the desalination plant 12. The double-headed arrow Y in FIG. 2 indicates the separation between the discharge outlets 28a-d and seawater inlets 46 which extend downwards from the stern 48 of the vessel 10. The separation Y is between about 250 m and 12 km.

The system for transporting fresh, desalinated water to shore will now be described briefly. Freshwater tanks 50 onboard the vessel 10 are used to store the desalinated water produced by the desalination plant 12. Although not shown in the drawings, in other embodiments of the invention, the freshwater tanks 50 may be located in the hull of the vessel 10. The freshwater tanks 50 are connected to the freshwater pipeline 16, which is disposed on the seabed 18, by one or more dynamic risers 52 which are arranged over a second arch-shape buoyancy aid 54 tethered to a second base 56 on the seabed 18. A third PLEM 58 located adjacent to the second base 56 connects the dynamic risers 52 to the freshwater pipeline 16. The freshwater pipeline 16 extends along the seabed 18 to an onshore processing or distribution plant (not shown). In use, desalinated water is pumped from the freshwater tanks 50, down through the dynamic risers 52 and along the freshwater pipeline 16 to the onshore processing or distribution plant.

Referring now to FIG. 3, which shows the vessel 10 moored to a Catenary Anchor Leg Mooring (CALM) buoy 60. The CALM buoy 60 replaces the fixed mooring 15a-d shown in FIGS. 1 and 2, and allows the vessel 10 to rotate freely about the CALM buoy 60 in order to adjust to the tide and/or prevailing weather conditions. The vessel 10 is attached to the CALM buoy 60 by a number of wires and/or ropes (not shown in FIG. 3) which extend from the bow 62 of the vessel 10 to the CALM buoy 60. The CALM buoy 60 is, in turn, anchored to the seabed 18 by tethers 64.

In this example, a first pair of pipes 65 connect the effluent tanks 34 onboard the vessel 10 to a manifold 66 at the bow of vessel 10. The freshwater tanks 50 are also connected to the manifold 66 by a second pair of pipes 67. A pair of flexible connecting pipes 68 extend from the manifold 66 to the CALM buoy 60, with effluent being channeled through one of these connecting pipes 68, and freshwater being channeled through the other connecting pipe 68. There is slack 69 in the connecting pipes 68 so that the vessel 10 can move apart from the CALM buoy 60 in accordance with the tide and weather conditions.

At the CALM buoy 60, the connecting pipes 68 are respectively connected to a pair of dynamic risers 32, 52. In this example, both of the dynamic risers 32, 52 are disposed over a single underwater arch-shaped buoyancy aid 54 which is tethered to a concrete base 56 on the seabed 18. However, in other embodiments, the dynamic risers 32, 52 could be disposed over separate underwater buoyancy aids in a similar arrangement to that shown in FIG. 2. The dynamic risers 52 are connected to respective PLEMS 42, 58 located on either side of the base 56. The primary discharge pipe 24 and freshwater pipeline 16 extend from these PLEMs 42, 58 in much the same way as that described with reference to FIGS. 1 and 2.

The combination of a CALM buoy 60 and the dynamic risers 32, 52 described above, allows the vessel 10 to move about without stresses arising in respective connections to the primary discharge pipes 24 and the freshwater pipeline 16 on the seabed 18. This allows the desalination plant 12 to operate effectively in all weather conditions.

FIGS. 5 and 6 show an alternative embodiment of the invention, in which the vessel 10 incorporating the desalination plant 12 employs a turret mooring assembly 70 in the bow 62 of the vessel 10 instead of the CALM buoy 60 described with reference to FIGS. 3 and 4. FIG. 5 is a plan view of the vessel 10 in which it can be seen that a cylindrical bore 72 extends through the bow 62 of the vessel 10. The cylindrical bore 72 accommodates the turret mooring assembly 70. A freshwater pipe 67 and an effluent pipe 65 extend from tanks 50, 34 on the vessel 10 to the turret mooring assembly 70 where they are connected to a pair of dynamic risers 32, 52 which are surrounded by a single flexible outer sleeve 74 as best seen in the schematic elevation of FIG. 6.

The dynamic risers 32, 52 surrounded by the outer sleeve 74 extend from the vessel 10 to the seabed 18, where they are respectively connected to the freshwater pipeline 16 and the primary discharge pipeline 24 by PLEMs 58, 42. The dynamic risers 32, 52, within the outer sleeve 74, are disposed over a single underwater buoyancy aid 54, although other arrangements are possible as discussed above with reference to FIGS. 1 to 4.

The turret mooring assembly 70 enables the vessel 10 to rotate about variable bearings. In this embodiment the turret mooring assembly 70 comprises a split-cylinder configuration in which an upper cylinder 76 and a lower cylinder 78 are separated by a bearing assembly 80. The upper cylinder 76 is fixed to the vessel 10, and the lower cylinder 78 is anchored to the seabed 18 by mooring lines 82a-d. The bearing assembly 80 allows the upper cylinder 76 to rotate relative to the lower cylinder 78, the lower cylinder 78 having a substantially fixed orientation by virtue of the mooring lines 82a-d to the seabed 18. The turret mooring assembly 70 allows the vessel 10 to rotate in the water relative to the dynamic risers 32, 52. In other embodiments of the invention, different designs of turret mooring assembly 70 may be employed.

The dynamic risers 32, 52 remain substantially unaffected by rotation of the vessel 10 such that stresses in the connections to the respective pipelines 16, 24 on the seabed 18 are minimised. The provision of the turret mooring assembly 70 enables the vessel 10 to be moved between locations more readily than with the CALM buoy 60, since the mooring system is integral with the vessel 10.

The examples described above are for illustrative purposes only and many modifications or variations may be made to these systems within the general ambit of the invention. For example, the specific pipe arrangements described in the examples above may be varied depending on, amongst other factors, the scale of the desalination plant 12. In other embodiments of the invention, there may be more than, or fewer than four secondary discharge pipes 26a-d.

Whereas the freshwater pipeline 16 and the discharge pipes 24, 26a-d are disposed on the seabed 18 in the examples described above, in other embodiments some, or all of these pipes may float on the surface 71 of the sea 14. In such systems, the effluent may be discharged closer to, or on the surface 71 of the sea 14.

Although the reverse osmosis technique is mentioned specifically, the invention is not limited to this method of desalination, and indeed any other suitable desalination technique may be employed. Furthermore, although the term ‘sea’ has been used throughout the description, this is not intended to limit the scope of the invention, which is equally suitable for use in any other such body of salt or brackish water. Further still, the invention may also be put to effect in a body of fresh water, such as a lake, in which case the plant would be a water purification plant rather than a desalination plant.

1. An apparatus for discharging effluent from a water-based vessel (10), the apparatus comprising:
means for causing the effluent to be introduced into the water at a plurality of discharge locations relative to the vessel (10), wherein the discharge locations are remote from each other thereby causing the discharged effluent to be dispersed in the surrounding water.

2. The apparatus of claim 1, further comprising conveying means for conveying the effluent to the plurality of discharge locations, the conveying means having a plurality of outlets (28a-d) through which, in use, the effluent is discharged.

3. The apparatus of claim 2, wherein the conveying means comprises a branched pipe assembly (22) having one or more inlet pipes (24) connected to a plurality of outlet pipes (26a-d).

4. The apparatus of claim 3, wherein the outlets (28a-d) are defined by respective open ends of the outlet pipes (26a-d).

5. The apparatus of claim 3 or claim 4, further comprising a manifold (44) having one or more manifold inlets and a plurality of manifold outlets, wherein the one or more inlet pipes (24) are respectively connected to the one or more manifold inlets, and the plurality of outlet pipes (26a-d) are respectively connected to the plurality of manifold outlets.

6. The apparatus of any one of claims 3 to 5, wherein the length of each outlet pipe (26a-d) is between 200 m and 10 km.

7. The apparatus of any one of claims 3 to 6, wherein the length of the or each inlet pipe (24) is between 50 m and 2 km.

8. The apparatus of any one of claims 2 to 7, further comprising a riser (32) for connecting the conveying means to a source of effluent onboard the vessel (10).

9. The apparatus of claim 8, further comprising an underwater buoyancy aid (36) for supporting the riser (32) part-way along its length.

10. The apparatus of any preceding claim, further comprising diluting means (34) for diluting the effluent before it is discharged.

11. The apparatus of claim 10, wherein the diluting means (34) is arranged to mix the effluent with seawater before it is discharged.

12. The apparatus of any preceding claim, wherein the discharge locations are spaced apart by at least 200 m.

13. The apparatus of any preceding claim, wherein the discharge locations are remote from the vessel (10).

14. A method of discharging effluent from a water-based vessel (10), the method comprising introducing effluent into the water at a plurality of discharge locations relative to the vessel (10), wherein the discharge locations are remote from each other such that the discharged effluent is dispersed in the surrounding water.

15. The method of claim 14, further comprising conveying effluent to the plurality of discharge locations.

16. The method of claim 15, wherein the effluent is conveyed through a plurality of pipes (24, 26a-d).

17. The method of claim 16, wherein the effluent is conveyed through a branched pipe assembly (22).

18. The method of any one of claims 14 to 17, wherein the discharge locations are spaced apart from each other by at least 200 m.

19. The method of any one of claims 14 to 18, wherein the discharge locations are remote from the vessel (10).

20. The method of claim 19, wherein the discharge locations are between 250 m and 12 km from the vessel (10).

21. The method of any one of claims 14 to 20, wherein the discharge locations are underwater.

22. The method of claim 21, wherein the discharge locations are substantially on the seabed (18).

23. The method of any one of claims 14 to 22, further comprising mixing the effluent with seawater before it is discharged.

24. The method of any one of claims 14 to 23, wherein the effluent is concentrated brine.

25. The method of claim 24, wherein the concentrated brine is produced by a desalination plant (12) onboard the vessel (10).

26. The method of claim 25, further comprising pumping the desalinated water to the shore from the vessel (10) through one or more pipes (16).

27. The method of claim 25, further comprising transporting the desalinated water to the shore in one or more containers.

28. The method of claim 27, wherein the containers are transported to the shore by another vessel.

29. A vessel-based water purification plant (12) comprising:
a first riser (52) connecting a source of purified water (50) onboard the vessel (10) to a fresh water pipeline (16) disposed substantially on the seabed (18), and
a second riser (32) connecting a source of effluent (34) onboard the vessel (10) to a discharge pipeline disposed substantially on the seabed (18),
the arrangement being such that purified water is pumped to shore through the fresh water pipeline (16), and effluent, which is produced during purification, is discharged into the sea (14) through the discharge pipeline (24).

30. The vessel-based water purification plant (12) of claim 29, wherein the first and second risers (52, 32) are flexible pipes.

31. The vessel-based water purification plant (12) of claim 30, wherein each riser (32, 52) is supported part-way along its length by a buoyancy device (36, 54) located underwater.

32. The vessel-based water purification plant (12) of claim 31, wherein the or each buoyancy device (36, 54) is tethered to a respective base (38,56) on the seabed (18).

33. The vessel-based water purification plant (12) of claim 31 or claim 32, wherein the risers (32, 52) are arranged such that there is a portion of slack (40) between the or each buoyancy device (36, 54) and the vessel (10).

34. The vessel-based water purification plant (12) of any one of claims 29 to 33, wherein the vessel (10) is moored to a buoy (60).

35. The vessel-based water purification plant (12) of claim 34, wherein the buoy (60) is a catenary anchor leg mooring (CALM) buoy.

36. The vessel-based water purification plant (12) of any one of claims 29 to 33, further comprising a turret mooring assembly (70) integral with the vessel (10).

37. The vessel-based water purification plant (12) of any one of claims 29 to 36, wherein the discharge pipeline comprises a branched pipe assembly (22) having a plurality of outlets (28a-d) through which the effluent is discharged.

38. The vessel-based water purification plant (12) of claim 37, wherein the branched pipe assembly (22) comprises a plurality of pipes (26a-d) which fan out from a common point towards open ends that define the outlets (28a-d).

39. The vessel-based water purification plant (12) of claim 37 or claim 38, wherein said plurality of outlets (28a-d) are separated from one another by at least 200 m.

40. The vessel-based water purification plant (12) of any one of claims 37 to 39, wherein the outlets (28a-d) are located between 250 m and 12 km from the vessel (10).

41. The vessel-based water purification plant (12) of any one of claims 29 to 40, and arranged to produce between 5,000 and 150,000 m³ of purified water per day.

42. The vessel-based water purification plant (12) of any one of claims 29 to 41, wherein the water purification plant is a desalination plant, and the effluent is concentrated brine.
